(19) United States
(12) Patent Application Publication
(10) Pub. No.: US 2012/0164449 A1
(43) Pub. Date: Jun. 28, 2012

(54) FIBERS WITH IMPROVING ANTI-MICROBIAL PERFORMANCE

(76) Inventor: Stephen Woodrow Foss, Naples, FL (US)

(21) Appl. No.: 13/335,349

(22) Filed: Dec. 22, 2011

Related U.S. Application Data
(60) Provisional application No. 61/426,618, filed on Dec. 23, 2010.

(51) Int. Cl. D02G 3/36; D01F 1/10; B29C 47/00; C08L 23/06; C08L 77/00; C08K 11/00; C08L 67/02; C08L 67/04; C08L 67/00; C08K 3/08; C08K 5/49; D02G 3/04; C08L 23/12

(52) U.S. Cl. 428/389; 428/401; 264/211; 264/148; 264/103; 264/129; 523/122

(57) ABSTRACT

Fibers and fabrics with improved anti-microbial activity in after laundering, and a method of producing the same, are described. One embodiment includes a method for generating a synthetic fiber, the method comprising creating a mixture, the mixture comprising a polymer, an anti-microbial agent, and a dispersion liquid, and extruding the mixture to form a synthetic fiber.

### PRIORITY

The present application claims the benefit of commonly owned and assigned provisional application no. 61/426,618, filed Dec. 23, 2010, entitled “Fibers with Improving Anti-Microbial Performance,” which is incorporated herein by reference.

### FIELD OF THE INVENTION

The present invention relates fibers and fabrics designed for the effective destruction of pathogens such as bacteria, mold, mildew, fungus, spores, and viruses.

### BACKGROUND OF THE INVENTION

Anti-microbial additives containing copper, silver, gold, and zinc, either individually or combined, are known to be effective against pathogens such as bacteria, mold, mildew, virus, spores, and fungus. Accordingly, fibers and fabrics have been produced with anti-microbial alloys in various synthetic polymers such as polyester, polypropylene, nylon, rayon, and polylactic acid (PLA). There are many uses and applications for these types of anti-microbial fibers and fabrics, including the healthcare industry, hospitality industry, military, and infant care, among others. However, current anti-microbial fibers and fabrics have shortcomings in meeting the requirements of these uses and applications.

For example, in the healthcare and hospitality industry—such as in a hospital, nursing homes, extended care facilities, hotels, spas or the like—it is required that privacy curtains, isolation gowns, sheets, towels, scrubs, doctor's coats, bath robes, pajamas, and uniforms for medical personnel, both be sanitary and be perceived as sanitary. Therefore, the healthcare and hospitality industries require that these fabrics and garments conform to certain sanitation criteria. As there has been a rise in the possibility of contracting various contagious diseases such as Methicillin-resistant Staphylococcus aureus (MRSA) over the past few years, most in the healthcare industry now require bleaching of the towels, garments and other fabrics used in hospitals and various places where repeated use of the towels, garments and fabrics will, or is likely to, occur. This, of course, eliminates many of the types and colors of towels, garments and fabrics that can be used in the healthcare industry and is one reason why most of the fabrics are white. Moreover, because fibers and fabrics produced with known methods lose their effectiveness during repeated launderings with chlorine bleach, the laundering process required in these industries causes issues with known anti-microbial fibers and fabrics.

In addition, high count woven fabrics, such as sheets, uniforms, doctor's coats, and scrubs require high tenacity fibers (typically greater than 6 grams per denier) to weave without problems. Generally, fibers with a significant amount of additives are unable to reach that level of tenacity.

During weaving, it is necessary to apply a starch (PVA) to the yarns to give them better abrasion resistance during weaving. However, the starch is typically organic and provides a food source for bacteria, stiffens the fabric, and is not desirable for softness and touch. The starch must be removed and it is desirable to be able to add a topical treatment that is compatible with the additive in the fiber.

Additives of copper, silver, gold, zinc and other metals are difficult to disperse into molten polymers such as PET, especially with a particle size of 0.3 to 0.6 microns. Generally, these alloys are used as a master-batch, pre-dispersed in a carrier such as polyethylene, polypropylene, polyester, or PBT. Often, when a master batch is made in an extruder there are two detrimental effects: the additional heat of the process adds a second heat cycle to the additive which can reduce effectiveness, and the process can cause agglomerates, which may be filter out in the filter screen and either clog the screen or reduce the concentration of the master batch.

Moreover, the structure of the weave can affect the porosity of the fabric and thus the ability of the bacteria to come in contact with the fibers and the active ingredients. Most synthetic fibers maintain an impermeable skin on the outside of the fiber, preventing exposure of the anti-microbial alloys. U.S. Pat. Nos. 6,723,428; 6,841,244; and 6,946,196 by Stephen W. Foss, et al, teach that by putting the silver additive only in the sheath of a Bi-component fiber, the efficacy can be improved by forcing the active ingredient to the surface. However, there is a need to be able to add the alloy powder directly to the fiber polymer during fiber manufacture.

In addition, there is a need to create a mechanism to open pores or striations on the surface of fibers to increase the surface area and expose more active ingredients to the microbes. Thus, the need exists for an anti-microbial fabric that will resist the destructiveness of washing in chlorine bleach and maintain its color and efficacy against pathogens such as: gram-negative bacteria, gram-positive bacteria, mold mildew, fungus, spores, and virus and not be degraded during repeated launderings and uses.

Although present devices and methods are functional, they are not sufficiently effective or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the present invention comprises a method for generating a synthetic fiber, the method comprising creating a mixture, the mixture comprising a polymer, an anti-microbial agent, and a dispersion liquid, and forming a synthetic fiber from the mixture. Is some methods, forming the synthetic fiber may include an extrusion process or a continuous polymerization process. In some embodiments, the method may further include treating the fiber with an anti-microbial metallic solution and/or blending the fiber with a cellulosic fiber. The method may further generating a fabric using the fiber and then heat setting the fabric to impart permanent press characteristics to prevent wrinkling.

In another embodiment, the invention may comprise a synthetic fiber comprising a polymer, an anti-microbial agent, and a dispersion liquid, wherein the dispersion liquid is embedded in the fiber. The anti-microbial agent may be comprised of silver and/or copper and/or zinc and/or gold in metallic form, salt form or ionic form and the dispersion liquid may be selected from the group consisting of an anti-stat, an anionic anti-stat oil, a phosphate ester, a wax, and a vegetable oil. The fiber may range from 0.5 to 20 denier, or preferably from 1.0 to 3.0 denier. The synthetic fiber can be a portion of an air jet spun yarn, and/or can be used in a sheet, pillow case, privacy curtain, isolation gown, medical scrubs, doctor coat, or blanket. In some embodiment, the synthetic fiber may further comprise cellulosic fibers and/or a metallic anti-microbial coating.

In yet another embodiment, the present invention is a synthetic fiber comprising a polymer, an anti-microbial agent, and a dispersion additive, wherein the fiber was infused with the dispersion additive prior to formation.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 includes a flow chart for an exemplary method of producing fibers consistent with an embodiment of the present invention.

FIGS. 2A and 2B are illustrations of an anti-microbial fiber consistent with embodiments of the present invention.

### DETAILED DESCRIPTION

The present invention provides methods for generating fibers and fabrics with improved anti-microbial properties and characteristics. The present invention further relates to the fibers themselves. In a preferred embodiment, the present invention includes fibers that have been infused with an anti-microbial agent and a dispersion liquid, and which exhibit improved performance with repeated launderings.

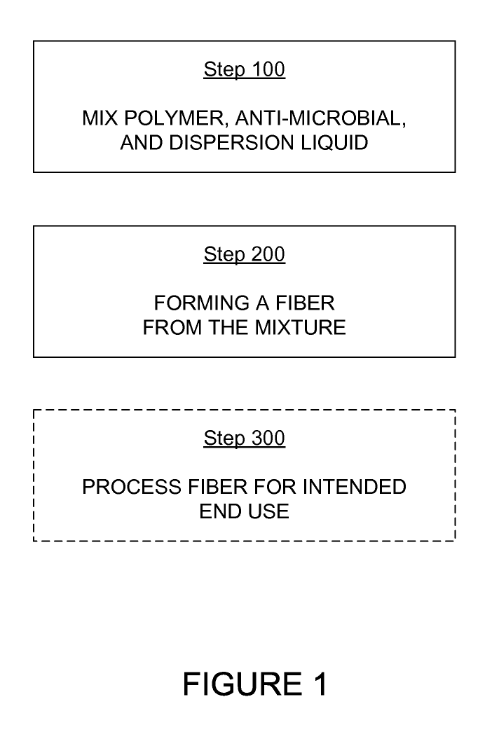

Referring first to FIG. 1, there is an illustration of a method for generating fibers with improved anti-microbial properties and characteristics. At Step 100 a mixture is created, the mixture including a polymer, an anti-microbial alloy powder, and a dispersion liquid. As used herein, a polymer refers to a compound suitable for fiber and fabric generation including, but not limited to, a thermoplastic polymer, polyester, nylon, rayon, polyethylene (PE), polypropylene (PP), polyethylene terephthalate (PET), polyethylene terephthalate glycol (PETG), co-PET, polylactic acid (PLA), and polytrimethylene terephthalate (PTT). In a preferred embodiment, the polymer may be PET, for its strength, longevity during washing, ability to be made permanent press, and ability to be blended with other fibers. In another embodiment, the polymer may be Nylon 6,6 may. Nylon is known to be a stronger fiber than PET and exhibits a non-drip burning characteristic that is beneficial in military applications, and is more hydrophilic than PET.

An anti-microbial agent may be any suitable anti-microbial, such as silver, copper, zinc and/or gold in metallic forms (e.g., particulates, alloys and oxides), salts (e.g., sulfates, nitrates, acetates, citrates, and chlorides) and/or in ionic forms. In some embodiments, the anti-microbial agent is an anti-microbial alloy powder with a particle size of less than 1 micron, and preferably 0.3 to 0.6 micron.

The anti-microbial agent may be comprised of an anti-microbial powder formed from alloys of one or more metals that exhibit anti-microbial properties. Anti-microbial alloys made of two or more element alloys can have superior anti-microbial properties compared to one element particles. Embodiments of the present invention can include an anti-microbial alloy which includes a combination of: transition metals of the periodical table such as chromium, manganese, iron, cobalt, nickel, copper, zinc, silver, and/or gold; rare earth metals from the lanthanides such as cerium, neodymium, samarium, gadolinium, terbium, dysprosium, holmium, and/or erbium; and/or alkali metals such as lithium, sodium, potassium, magnesium, and/or calcium. The combination may comprise a binary combination, ternary combination, quaternary combination, or even higher order combination. The selected alloys, and the relative percentages of each alloy, may be selected depending on the intended use of the fiber or other selection criteria. Different combinations will result in different anti-microbial classes that may be used with the present invention.

For example, different classes of anti-microbial alloys have been produced by QuarTek Corporation as described in various patent applications (U.S. Provisional Application Nos. 60/888,343 and 60/821,497 filed on Aug. 4, 2006 and U.S. patent application Ser. Nos. 11/868,475 filed on Oct. 06, 2007, 11/858,157 filled on Sep. 20, 2007, and 11/671,675 filed on Feb. 6, 2007). These anti-microbial alloys have been produced by varying the elemental composition of the alloys, the elemental ratios within the same alloy, or by changing parameters in the synthesis process. As needed, these anti-microbial alloys may be synthesized in various size ranges from 5 nm to 2000 nm, preferably less than 1000 nm, or even within the range of 100-500 nm.

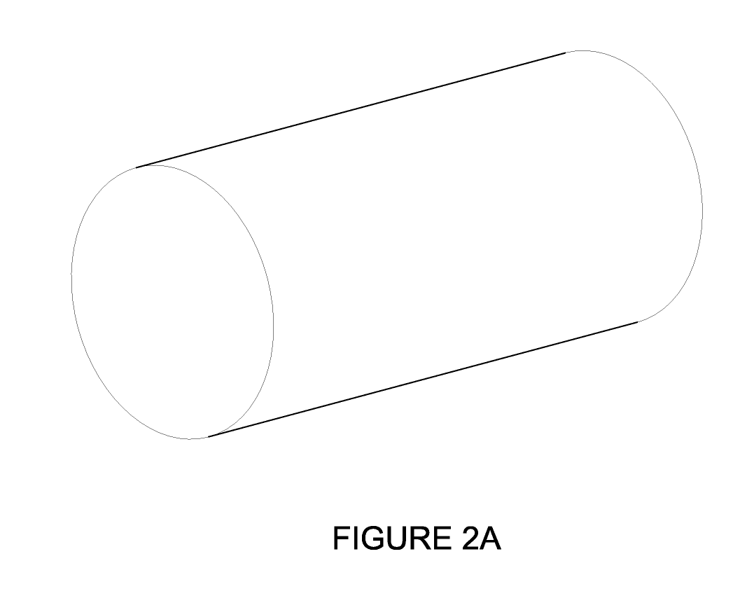

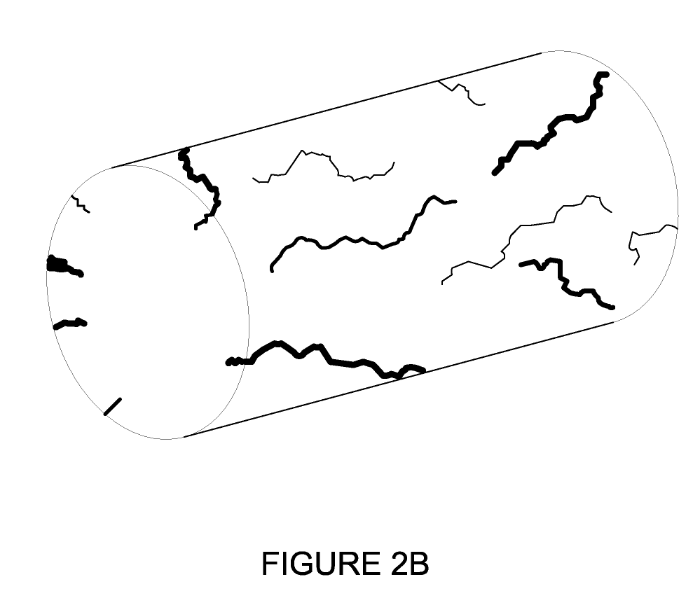

A dispersion liquid, as introduced above, is a liquid additive used to disperse the anti-microbial agent and assist with the combination of the anti-microbial agent and the polymer. This allows for more uniform dispersion of the anti-microbial agent throughout the eventual fiber. Further, this combination “welds” the anti-microbial within the polymer to help prevent or limit the active anti-microbial ingredients from being washed from the fiber. The dispersion liquid itself is embedded in the fiber during manufacture but at least a portion of the dispersion liquid dissolves from the fiber during treatments, or launderings, creating cracks and/or striations in the fiber and further exposing the anti-microbial agent in the fiber to any pathogens. For example, FIGS. 2A-2B show illustrations of an anti-microbial fiber consistent with embodiments of the present invention. FIG. 2A illustrates a fiber just after manufacture, while FIG. 2B illustrates cracks and/or striations in the fiber after treatments, or launderings, that dissolve or otherwise remove some of the dispersion liquid. These cracks or striations in the fiber further expose the anti-microbial agent embedded in the fiber to any surrounding pathogens.

Exemplary dispersion liquids include anti-stats, anionic anti-stat oils, phosphate esters, vegetable oils, and other liquids. In one embodiment, the dispersion liquid may be comprised of predominately a phosphate ester with 10-30% water. In another embodiment, the dispersion liquid may be comprised of certain waxes, such as Montan Wax that operates to carry powders into fiber. The selection of the dispersion liquid may also relate to other desired characteristics of the fiber, including the desired tenacity, color, feel, etc.

Referring again to Step 100 in FIG. 1, in one embodiment creating the mixture may comprise first adding the dispersion liquid to polymer pellets in a tumbling mixer (similar to a concrete mixer) and then adding the anti-microbial agent. In another embodiment, the anti-microbial agent may be first mixed with the dispersion liquid and then added to the polymer. In another embodiment, the dispersion liquid may be sprayed on the polymer and an anti-microbial alloy powder mixed in as the dispersion liquid makes the polymer chips tacky and the powder adheres uniformly. Further variations and methods of combining the dispersion liquid, polymer and anti-microbial will be understood by those of skill in the art in view of the present disclosure.

As indicated by Step 200 in FIG. 1, once the mixture is created, the mixture may be extruded in order to create a fiber. The extrusion process itself depends on the temperature of the mixture being sufficiently high to melt the mixture. A melting step may be a separate step in FIG. 1 or it may be part of either the mixing process or the extruding process. When the mixture is at a sufficiently high temperature, the mixture may be extruded using conventional mechanisms such as a spinneret. The fiber may then be drawn, crimped, cut and spun into a yarn or other fabric depending on the intended end use.

In one embodiment, fibers consistent with the present invention will be between 0.5 to 20 denier, and preferably between 0.5 and 4.5 denier. The length of the fiber may vary depending on the intended use of the fiber, but a preferred range of lengths for the fibers may be 10 to 180 mm in length. The present invention further allows for a range of tenacities. In one preferred embodiment the tenacity is greater than four (4) grams per denier, while other embodiments will be greater than 6.2 grams per denier. Due to the advantages of the present invention, higher tenacity fibers (greater than 6.2, or even greater than 6.8 grams per denier) may be manufactured.

In another embodiment, the anti-microbial powder and the dispersion liquid are mixed together and injected into the continuous polymerization of the polymer and then directly spun into fiber without the extrusion step.

There are numerous post-fiber-creation techniques (Step 300) that may be used in order to further enhance the characteristics of the fiber. In one embodiment, an air jet spinning method may be used on the anti-microbial fibers in order to increase the bulkiness of the yarn and to make the yarn fuzzier. These air jet spun yarns expose more surface area of the fiber to bacteria in order to improve the anti-microbial characteristics of the fiber. In another embodiment, the anti-microbial fiber may be blended with cellulosic fibers such as cotton, rayon, Tencel®, etc. to enhance the moisture available near the anti-microbial fiber, improving the efficacy of the fibers at killing pathogens.

After the fibers have been converted to yarns and then to fabrics, post finishing in hot water (85° C. or greater) to remove the weaving starch and start the emulsion of the dispersion liquid. A topical finish (or coating) containing additional copper, silver, and/or zinc with a latex binder, such as Ethylene Vinyl Acetate (EVA) or Acrylic, may be applied to create a chemical bond with the active additives in the fiber. The effect of creating striations on the fiber after initial washing to remove starch, provides a unique chemical and mechanical bond of the binder with the fiber, connecting the antimicrobial additives.

The present invention permits fibers that are infused with anti-microbial compounds to be heat set at 180° C. to make the fabrics permanent press without degradation of the anti-microbial properties. Being able to permanent press a fabric according the present invention offers numerous advantages beyond just improving appearance or reducing laundering time. For example, permanent press sheets are less likely to wrinkle, which can improve patient comfort and potentially reduce bed sores.

Fibers consistent with the present invention are able to meet the Clorox 5X test, and can even exhibit improved bacteria killing performance after repeated washing with Clorox bleach and tide. The Clorox-5X test uses the common bleaching agent and the bleaching agent found in Clorox® stbleach, sodium hypochlorite, in a series of bleaching cycles to determine whether the fabric will withstand chlorine bleaching. The Clorox-5X test refers to bleaching of the fabric through five (5) cycles. The Clorox-1X test refers to bleaching of the fabric through one (1) cycle. A cycle includes bleach washing a test sample with the bleaching chemical known by the trade name Clorox, in water with Chlorox and detergent at 40° C., for 20 minutes.

During a laundering process, such as the Clorox-5X test, some of the dispersion liquid within the fiber may be dissolved and removed, leaving cracks in the fiber that further expose the anti-microbial imbedded within the fiber to any pathogens. Accordingly, the laundering process can increase the anti-microbial effectiveness of the fiber.

In some embodiments, fibers consistent with the present invention may be further treated with an anti-microbial post fabrication. In this manner, although the effectiveness of the post-fabrication anti-microbial treatment may decrease over time, the effectiveness of the fibers will remain constant or increase over time due to the increased exposed surface area of the fiber as the dispersion liquid disintegrates away.

An exemplary fiber consistent with embodiments of the present invention was made using 99.3% Polyester (PET) resin of 0.64 IV blended with 0.4% QuarTek Alloy QSM-ACL73, 0.1% Phosphate Ester Anti Stat, and 0.2% pthalo blue pigment. The alloy was a powder with particle sizes of 0.4-0.6 microns. The alloy powder was dried in a convection oven at 150° C. for 24 hours. The hot PET resin was removed from the desiccant drier at 125° C. FibroChem Anti-Stat 101A (an anionic anti-stat oil) was added to the PET pellets at a rate of 0.5 liter per 1,000 pounds by carefully drizzling the oil with a brush. The powder alloy was then added slowly to the mixture of PET pellets and anti-stat oil in a tumbling mixer (similar to a concrete mixer) and mixed for 5 minutes.

The compounds were extruded at a melt temperature of 290° C. and pumped through a spinneret to produce a fiber of 5.5 denier. The fiber was then drawn to 1.3 denier, crimped, and cut to 1.5″ (38 mm). During the drawing, a draw ratio was increased from a typical 3.3:1 to 3.7:1 which produced a fiber with a tenacity of 6.2 grams/denier.

In this exemplary embodiment, the fibers were then spun into a yarn and knitted in a tube. The knitted tubes were tested for bacteria using AATCC test #100. Unwashed the knitted tubes showed a 99.9% kill rate. The knitted tubes were then washed twenty-five (25) times using hot water, chlorine bleach, and detergent. After being washed, the knitted tubes were again tested, this time showing a 99.999% kill rate.

In another exemplary embodiment, similar fibers were generated in a production run of 5,000 pounds. The fibers were spun using air-jet yarn spinning to produce yarns which were bulky and allowed fibers to be available on the surface. The yarns were woven in different constructions using starch (PVA) to aid in the weaving.

The woven fabrics were scoured in a finishing mill at 85° C. to remove the starch, dried at 150° C. and then heat set at 180° C. to make the fabric “permanent press”. The fabric was then post-finished with a solution containing copper, silver & zinc with a acrylic latex binder that attached to the fibers providing dual protection-inside and outside the fibers. Because the anti-stat oil started to dissolve in the hot water, there were small cracks formed in the surface of the fiber that provided a chemical and mechanical bond.

Fabrics consistent with this embodiment were made into sheets, pillow cases, privacy curtains, isolation gowns, scrubs, doctor's coats, and blankets. Once again, these fabrics were tested using the AATCC 100 test. All fabrics provided results better than 99.99% kill rates and most were 99.999% after 25 launderings with Clorox, detergent, and hot water. The fibers are also suitable for use in nonwovens.

In conclusion, the present invention provides, among other things, a system and method for making fibers which improve anti-microbial activity after repeated launderings. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for generating a synthetic fiber, the method comprising:
creating a mixture, the mixture comprising a polymer, an anti-microbial agent, and a dispersion liquid, and
forming a synthetic fiber from the mixture.

2. The method of claim 1, wherein the polymer is selected from a group consisting of a thermoplastic polymer, polyester, nylon, rayon, polyethylene (PE), polypropylene (PP), polyethylene terephthalate (PET), polyethylene terephthalate glycol (PETG), co-PET, polylactic acid (PLA), and polytrimethylene terephthalate (PTT).

3. The method of claim 1, wherein the anti-microbial agent comprises QuarTek Alloy QSM-ACL73.

4. The method of claim 1, wherein the anti-microbial agent comprises an anti-microbial alloy powder.

5. The method of claim 1, wherein the dispersion liquid is selected from the group consisting of an anti-stat, an anionic anti-stat oil, a phosphate ester, a wax, and a vegetable oil.

6. The method of claim 1, wherein:
creating the mixture comprises mixing polymer pellets, the dispersion liquid, and the anti-microbial alloy powder in a mixer; and
extruding the mixture to form the synthetic fiber comprises:
heating the mixture to a melt temperature; and
pumping the mixture through a spinneret.

7. The method of claim 1, wherein extruding the mixture to form the synthetic fiber comprises forming the fiber with a linear mass density of 0.5 to 20 denier.

8. The method of claim 1, further comprising cutting the synthetic fiber at a length of 10 to 180 mm.

9. The method of claim 1, wherein extruding the mixture to form the synthetic fiber comprises forming the fiber with a tenacity greater than 4.

10. The method of claim 1, further comprising:
using the fiber to create a fabric.

11. The method of claim 11, further comprising:
heat setting the fabric to impart permanent press characteristics to prevent wrinkling.

12. The method of claim 1, further comprising:
blending the fiber with a cellulosic fiber.

13. The method of claim 1, further comprising:
treating the fiber with an anti-microbial metallic solution.

14. The method of claim 1, further comprising:
washing the fiber to dissolve at least a portion of the dispersion liquid out of the fiber.

15. The method of claim 1, wherein forming the synthetic fiber comprises:
extruding the mixture to form the synthetic fiber.

16. The method of claim 1, wherein forming the synthetic fiber comprises a continuous polymerization process wherein the mixture is directly injected during or downstream of the polymerization process and spun into the synthetic fiber.

17. A synthetic fiber comprising:
a polymer;
an anti-microbial agent; and
a dispersion liquid, wherein the dispersion liquid is embedded in the fiber.

18. The synthetic fiber of claim 17, wherein the anti-microbial agent comprises silver and/or copper and/or zinc and/or gold in metallic form, salt form or ionic form.

19. The synthetic fiber of claim 17, wherein the dispersion liquid is selected from the group consisting of an anti-stat, an anionic anti-stat oil, a phosphate ester, a wax, and a vegetable oil.

20. The synthetic fiber of claim 17, wherein the fiber is from 0.5 to 20 denier.

21. The synthetic fiber of claim 17 wherein the fiber is 1.0 to 3.0 denier.

22. The synthetic fiber of claim 17, wherein a tenacity of the fiber is greater than 4 grams per denier.

23. The synthetic fiber of claim 17, wherein the fiber is at least a portion of an air jet spun yarn.

24. The synthetic fiber of claim 17, wherein the fiber is at least a portion of a sheet, pillow case, privacy curtain, isolation gown, medical scrubs, doctor coat, or blanket.

25. The synthetic fiber of claim 17 further comprising cellulosic fibers.

26. The synthetic fiber of claim 17 further comprising a metallic anti-microbial coating.

27. The synthetic fiber of claim 26 wherein the metallic anti-microbial coating comprises:
a solution containing copper, silver, gold or zinc; and
a binder.

28. A synthetic fiber comprising:
a polymer;
an anti-microbial agent; and
a dispersion additive, wherein the fiber was infused with the dispersion additive prior to formation of the fiber.
